(19) United States
(12) Patent Application Publication
(10) Pub. No.: US 2013/0041853 A1
(43) Pub. Date: Feb. 14, 2013

(54) VALUATING ENERGY MANAGEMENT SYSTEMS

(71) Applicants: Edward Shnekendorf, Falls Church, VA (US); William Rebozo, Woodinville, WA (US); Catherine Christiaanse, Arlington, VA (US); Sarah Cartwright, Washington, DC (US)

(72) Inventors: Edward Shnekendorf, Falls Church, VA (US); William Rebozo, Woodinville, WA (US); Catherine Christiaanse, Arlington, VA (US); Sarah Cartwright, Washington, DC (US)

(73) Assignee: GridPoint, Inc., Arlington, VA (US)

(21) Appl. No.: 13/495,783

(22) Filed: Jun. 13, 2012

Related U.S. Application Data
(60) Provisional application No. 61/496,393, filed on Jun. 13, 2011.

(51) Int. Cl. G06Q 50/06

(52) U.S. Cl. 705/412

(57) ABSTRACT

A method including receiving data from an energy-consuming device; determining an amount of energy consumed by the device during a time interval; calculating an actual energy cost based on the determined amount of energy consumed by the device during the time interval; predicting an amount of energy that would have been consumed by the at least one device during the time interval if the at least one device were not associated with the energy management system; calculating a predicted energy cost based on the predicted amount of energy that would have been consumed by the at least one device during the time interval if the at least one device were not associated with the energy management system; and calculating a valuation of the energy management system for the at least one energy consuming device over the time interval by comparing the actual energy cost and the predicted energy cost.

### CROSS-REFERENCES TO RELATED APPLICATIONS

This application claims benefit under 35 U.S.C. §119(e) to U.S. Provisional Patent Application Ser. No. 61/496,393 filed on Jun. 13, 2011, and titled System and Method of Valuating Commercial and Industrial Energy Management Systems, which is hereby incorporated by reference in its entirety.

### BACKGROUND OF THE INVENTION

1. Field of the Invention

The invention relates generally to systems and methods of valuating commercial and industrial energy management systems. More specifically, the invention relates to systems and methods for determining and analyzing cost savings associated with an energy management system.

2. Description of the Related Art

Conventional systems for analyzing savings in an energy system have included various models. One model is called the Bin Method. The Bin Method is described in A Bin Method for Calculating Energy Conservation Retrofit Savings in Commercial Buildings, S. Thamilseran and J. Haberl, Proceedings of the Ninth Symposium on Improving Building Systems in Hot and Humid Climates, Arlington, Tex., May 19-20, 1994, which is hereby incorporated by reference in its entirety. Another model is called DOE2. DOE2 is described in DOE-2.2, Building Energy Use and Cost Analysis Program, Volume 1, Lawrence Berkeley National Laboratory, October 2004, which is hereby incorporated by reference in its entirety. Conventional systems for analyzing savings in an energy system have been directed to estimating pre-Energy Management System energy usage. For example, conventional savings analysis variants utilize monthly meter data or measure the total load of a building to compare present performance with historical performance. Energy usage profiles are established and normalized for weather to determine the magnitude of performance changes over an entire facility.

The prior art systems fail to provide a comprehensive picture of the true value of the Energy Management System, because the prior art systems fail to distinguish between various types of controls and state modifications that can result in monetary savings.

### BRIEF SUMMARY OF THE INVENTION

Various embodiments of the invention solve the above-mentioned problems by providing a discretized, broken-out analysis of savings achieved by distinct energy management modalities. Various embodiments relate to a method. According to some embodiments the steps of the method can be performed via a processor. Other embodiments relate to a non-transitory computer readable medium having computer-readable code stored thereon for causing a computer to perform the steps of the method.

Various embodiments relate to a method of valuating an energy management system implemented at a site. The method can include receiving data from at least one energy-consuming device. Data from a plurality of energy-consuming devices can also be received and valuated individually or collectively. The energy-consuming device can be selected from the group consisting of HVAC, lighting, refrigeration, climate control systems, manufacturing equipment systems, and combinations thereof. Other types of energy consuming devices may also be employed, such as energy consuming devices that run on natural gas, fuel oil, or other carbon-based fuels. The energy-consuming device can be associated with the energy management system. The data can include at least one operating parameter of the energy-consuming device for a given time interval.

The method can further include determining an amount of energy consumed by the device during the time interval; calculating an actual energy cost based on the determined amount of energy consumed by the device during the time interval; predicting an amount of energy that would have been consumed by the device during the time interval if the device were not associated with the energy management system; calculating a predicted energy cost based on the predicted amount of energy that would have been consumed by the device during the time interval if the device were not associated with the energy management system; calculating a valuation of the energy management system for the energy-consuming device over the time interval by comparing the actual energy cost and the predicted energy cost; and sending a representation of the valuation to a notification receiving device. The valuation can include an individual valuation for each of the plurality of energy-consuming devices or for a plurality of energy consuming devices.

The energy-consuming device can be associated with the energy management system in that the energy-consuming device is controlled by the energy management system, and the predicted amount of energy can be the amount of energy that would have been consumed by the device during the time interval if the device were not controlled by the energy management system.

The energy-consuming device can be associated with the energy management system in that the energy-consuming device is monitored by the energy management system, and the predicted amount of energy can be the amount of energy that would have been consumed by the device during the time interval if the device were not monitored by the energy management system.

The energy-consuming device can be associated with the energy management system in that the energy-consuming device is controlled and monitored by the energy management system and the predicted amount of energy can include a first prediction component and a second prediction component. The first prediction component of the predicted amount of energy can be the amount of energy that would have been consumed by the device during the time interval if the device were not controlled by the energy management system. The second prediction component of the predicted amount of energy can be the amount of energy that would have been consumed by the device during the time interval if the device were not monitored by the energy management system.

The valuation of the energy management system can include a first valuation component and a second valuation component. The first valuation component can provide or include a valuation of controlling the device with the energy management system, and the first valuation component can be determined by comparing the actual energy cost and the predicted energy cost based on the first prediction component of the predicted amount of energy. The second valuation component can provide or include a valuation of monitoring the at least one device with the energy management system, and the second valuation component can be determined by comparing the actual energy cost and the predicted energy costs based on the second prediction component of the predicted amount of energy.

The step of predicting the amount of energy that would have been consumed by the device during the time interval if the device were not associated with the energy management system can include applying a multi-variable linear regression based on at least 12 months of billing data for the site to construct a weather normalized model for the site.

The step of predicting the amount of energy that would have been consumed by the device during the time interval if the device were not associated with the energy management system can include evaluating at least one weather adjusted usage average of energy consumption at a second site.

The step of predicting the amount of energy that would have been consumed by the device during the time interval if the device were not associated with the energy management system can include evaluating at least one square-footage adjusted average of energy consumption at a second site.

The present technology provides for a multiple pre-retrofit estimation melded with monitoring-based monetization and supported by actual streams of detected data (channels).

### BRIEF DESCRIPTION OF THE DRAWINGS

These and other features, aspects, and advantages of the present invention will become better understood with reference to the following description and appended claims, and accompanying drawings where:

FIG. 1 is a block diagram illustrating an exemplary energy management system.

FIG. 2 is a chart of energy cost over time, illustrating the discretized, granular valuations that can be provided for potential savings maximization, according to various embodiments of the present technology; and

FIG. 3 is an exemplary user interface combining some the discretized, granular valuations into a unified and consistent savings model.

The figures illustrate diagrams of the functional blocks of various embodiments. The functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk or the like). Similarly, the programs may be stand alone programs, may be incorporated as subroutines in an operating system, may be functions in an installed software package, and the like.

It should be understood that the various embodiments are not limited to the arrangements and instrumentality shown in the drawings.

### DETAILED DESCRIPTION OF THE INVENTION

The present invention may be understood more readily by reference to the following detailed description of preferred embodiments of the invention as well as to the examples included therein. All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

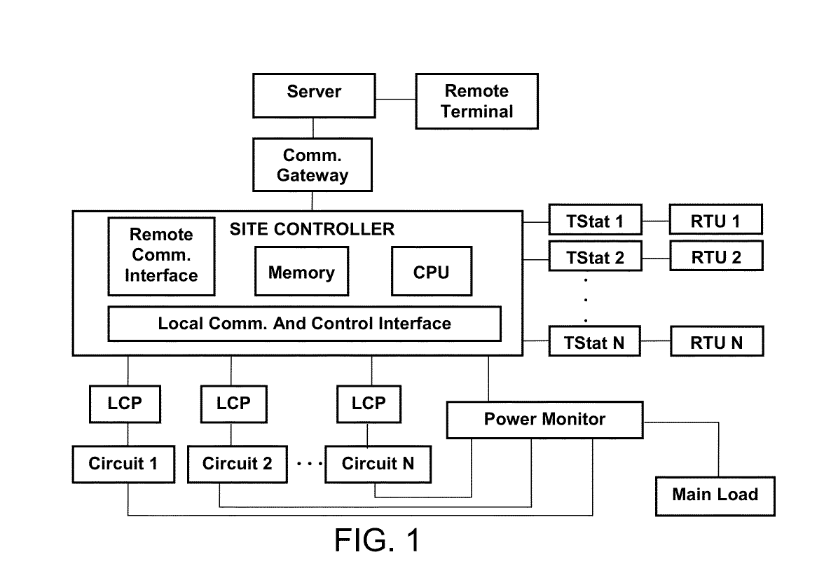

FIG. 1 shows a schematic block diagram illustrating an exemplary energy management system for practicing the invention. A site controller with embedded control algorithms controls multiple electrical loads on circuits 1 through N via light control panels (LCPs). The site controller is typically wired to common voltages at an electrical distribution panel of a commercial or residential building facility via a main line meter (power monitor). The site controller includes memory and a CPU for respectively storing and implementing energy management algorithms. The algorithms accept real-time power and environmental variable measurements (including readings from thermostats TStat 1 through TStat N) as inputs and determine how to control the power delivered on the circuits 1 through N and to control set points and other configurable settings such as enabling/disabling compressor stages on TStat 1 through TStat N. The site controller may include a power supply and one or more wired or wireless local communication and control interfaces for controlling Circuit 1 through Circuit N and TStat 1 through TStat N. Thermostats TStat 1 through TStat N provide temperature and humidity inputs to the site controller, and output control signals to roof-top units RTU 1 through RTU N. A communication interface provides bi-directional communication with a communication gateway, which in turn manages wired or wireless communications with a server or remote terminal.

One or more power monitors are coupled to the site controller either via wired or wireless connection. The power monitor includes hardware and firmware to provide sampling functionality, including multiple analog-to-digital converters for multi-channel fast waveform sampling of inputs such as current and voltage. The power monitor includes wired or wireless communication interfaces, current and voltage monitoring interfaces, memory, CPU, and may also include a power supply.

The current and voltage monitoring interfaces connect between the power circuits being monitored and the ND converter. Each channel may be connected to a separate power circuit to monitor the flow of current through the circuit. The connection is typically made with a current transformer at both a supply (i.e., hot) line and a return (i.e., neutral) line of the power circuit, which provides a waveform signal that is representative of the current flow at the connection point.

The site controller can detect alarm conditions based on the monitored data, raise alarms, and send alarm notifications to the server or remote terminal. Alternatively, the server or remote terminal can detect alarm conditions and raise alarms based on monitored data it receives from the site controller.

The energy management system can also control and monitor other power consuming devices and monitors other than lighting control systems and HVAC systems. For example, the energy management system can monitor and control refrigeration systems, generators, motors, irrigation systems, devices running on carbon-based fuel such as generators or furnaces, as well as monitoring temperature sensors, humidity sensors, boilers, and CO₂ sensors.

Embodiments of the invention provide systems and methods of valuating commercial and industrial energy management systems that provide many benefits:

Variant control-oriented models and the monetization of alarms and overrides, according to various embodiments, can provide for the determination and presentation of a comprehensive and optimal picture of savings.

Various embodiments allow for hardware integration, providing systems and methods of valuating commercial and industrial systems that monitor real data. For example, channel-level data provided by fielded hardware that can control variant sensors like current transducers (CTs), temperature probes, photocells, CO₂ sensors, door sensors, etc.

Systems and methods, according to certain embodiments, can be targeted to power-consuming systems commonly utilized in the commercial and industrial segment. For example, HVAC systems, refrigeration systems, lighting systems, climate control systems, manufacturing equipment systems, or other power-consuming systems. Power consuming systems may also include systems that consume natural gas, fuel oil, or other carbon-based fuel.

The systems and methods, according to various embodiments, can leverage business intelligence concepts to derive the expected performance of sites and equipment with a rich set of historical information. The intelligence is capable of “learning” energy profiles autonomously and monitoring systems in real-time across hundreds of thousands of endpoints.

The systems and methods, according to various embodiments, can be resilient to degradations in data and can provide a substantially accurate result given the amount of data possessed. If billing data is available, it can be used. In other embodiments, sub-metering data, DOE averages, or other data can be used.

Various embodiments of the invention valuate savings realized or realizable from controlling the energy consumption of one or more energy-consuming devices. Such embodiments can build a predictive model. For example, if a control-based energy management system has been installed at the site, the predictive model can predict an energy cost that would have been realized at the site had the control-based energy management system had not been installed. The energy cost prediction can be made for every time interval after the installation of the control-based energy management system. If a control-based energy management system has not yet been installed at the site, the predictive model can predict an energy cost that could be realized at the site if the control-based energy management system were installed. Again, the predictive model can operate on an ongoing basis, to make the energy cost prediction for every time interval after the control-based energy management system could have been made.

The predictive model can, in other words, provide a predictive baseline. For embodiments where an energy cost that would have been realized at the site had the control-based energy management system had not been installed is predicted, constructing the predictive baseline can be accomplished in a number of ways, including a site-to-self approach, a site-to-colleague approach, a site-to-peer approach, and combinations thereof.

A site-to-self approach can use a multi-variable linear regression based on 12 months of previous site billing data to construct a weather normalized model for the site in question. The weather normalized model can be adjusted for heating and cooling degree days. Changes, such as addition of new floor space, expansion or contraction of business hours, can be made after installing a control-based energy management system. These and other post-commissioning changes can be handled by implementing percentage-based model adjustments that are effective over certain time periods. For example, in the case of an addition of 100 square feet of floor space to a facility that originally included 1000 square feet of floor space a percentage-based model adjustment can include a 10% adjustment. A site-to-self approach can be particularly advantageous, because it can show benefit for a given site and can account for changes at the premises.

A site-to-colleague approach can build a predictive model based on weather and square-footage adjusted usage averages derived from pre-commissioning data of other sites in the customer's portfolio. A site-to-colleague approach can be particularly useful for enterprises that want to get a better idea not only of individual site improvement, but also of how that improvement looks within the context of other sites within their portfolio.

A site-to-peer approach can construct a baseline model even where reliable billing data is not available, based on weather and square-footage adjusted averages germane to the particular usage pattern as detailed in surveys such as the Department of Energy's Commercial Building Energy Consumption Survey (CBECS). A site-to-peer approach can be particularly useful in situations where an enterprise does not have a large portfolio of sites with energy management or where comprehensive billing data may not be available.

Each of these methodologies (site-to-self approach, site-to-colleague approach, and site-to-peer approach) can determine a quantitative value of potential benefits and disadvantages when it comes to calculating control-based savings by comparing current energy costs with a predicted energy cost that would have been realized at the site had the control-based energy management system had not been installed.

According to certain particularly preferred embodiments of the invention, when reliable and thorough sub-metering data is available, control savings can be further broken down by device class such as HVAC, lighting, refrigeration, etc.

Realizing savings through control changes is only one method. Various embodiments of the invention valuate savings realized or realizable from monitoring the energy consumption of one or more energy-consuming devices. Particularly preferred embodiments valuate both monitoring savings and control savings to provide an even more granular analytic experience.

Some sites may already be running through manual measures. As such implementing a control-based energy management system may not have a significant impact on their efficiency. Other sites may operate 24 hours a day, and therefore see little benefit from running lights or HVACs on a schedule. It is in these cases specifically, and all cases generally, that it is valuable or even critical to quantify the monetary value of monitored data.

Any type of exceptional classification, or alarm, is a condition that can be detected by monitoring one or more channels of data that holds true based on a pre-determined relationship expressed using those data values and optional external parameters (for example, a threshold) with a definitive start date and definitive (though not necessarily realized) close date. The energy monitoring system is responsible for detecting alarm occurrences (alarm open) as well as detecting when the exceptional condition has returned to normal (alarm close). The alarm can include a visual notification. For example, a pop-up window, email notification, text message, or other visual displayed on a notification receiving device of one or more personnel operating, controlling, or monitoring the commercial or industrial system. For example, the notification receiving device can be a central computer, a mobile phone, a smartphone, a computing device, a controller computer, or other computing device which can be configured to receive notifications of the alarms or representations of the alarms and monetization of the alarms. In other embodiments, the alarm can include an audible notification. For example, a horn, a siren, an automated voice message, or other audible notification. In other embodiments, the notification can include a combination of visual and audible notifications. The alarm can notify one or more personnel of the occurrence, continued persistence, and eventual close of the condition for the purpose of inducing action to clear the alarm in as timely a fashion as possible.

Alarms that can be derived from monitoring data should be monetizable and should contribute either to realized or unrealized savings, depending on whether or not notification results in timely action. The following are some examples of alarms that are prime candidates for monetization. Detection of lights remaining on all day in non-24 hour store can trigger an alarm that detects constant unnecessary operation of lights. Detection of manual overrides of a lighting schedule can trigger an alarm. Detection of manual overrides of a HVAC schedule can trigger an alarm. Detection of an abnormal heating/cooling can trigger an alarm, for example, by detecting one or more duct temperature values that are out of step with weather conditions. Detection of an ineffective HVAC compressor can trigger an alarm by correlating compressor activity with no impact on duct temperature. Detection of simultaneous heating and cooling can trigger an alarm based on a correlation of multiple HVACs at a single site working against each other. Detection of a freezer/cooler trend can trigger an alarm by detecting one or more elevated temperatures in a refrigeration unit. Detection of a polyphase voltage imbalance can trigger an alarm upon detecting an imbalance between the voltage legs present at a site.

Various embodiments of the invention provide domain specific “monetizers” to these alarms. For example, “monitizers” can include a valuation of a faulty unit associated with the alarm, a cost of running the unit in a non-efficient condition or mode, determining a cost of repairing or modifying the operation of the unit associated with the alarm, determining a cost of not repairing or modifying the operation of the unit associated with the alarm, or other valuation of the unit or units associated with the alarm. Some alarms can be monetized by applying a cost to unnecessary extra energy usage (e.g., lights on all day). Others can be monetized by showing the value of equipment, merchandise, or other capital placed at risk during the alarm period (e.g., Freezer/Cooler Trend, Polyphase Voltage Imbalance). Monetizers can also be used to estimate the cost of HVAC and lighting setbacks. Alarms that measure spikes in power/energy (like lighting alarms) can be monetized using a monetizer that applies incremental cost over a time period.

Conventional savings modules are not typically actionable. In other words, calculating the performance of an entire site does not enable an understanding of what actually contributes to the savings. This new approach enables an understanding of savings and fault prioritization at an equipment level.

According to one embodiment, a method of valuating an industrial management system can include receiving data from at least one device, said data representing an operation parameter of the at least one device. The method can also include comparing the received data to a predetermined threshold. An alarm can be raised in response to the comparison of the received data to the predetermined threshold. Raising an alarm can be in response to the received data being greater than the predetermined threshold. In another embodiment, raising an alarm can be in response to the received data being less than the predetermined threshold. The method can determine a monetization of the comparison of the received data to the predetermined threshold, in response to raising the alarm, and sending a representation of the monetization to a notification receiving device. In at least one embodiment, the method can further include receiving an input from a controller component, the input being indicative of a desired response to the alarm and adjusting the operation parameter of the device in response to the received input, the adjustment being based upon the comparison of the received data to the predetermined threshold. A system for valuating a commercial or industrial management system can include one or more hardware components configured to execute any or all of the method steps described above.

For example, in at least one embodiment, the present technology provides for a system and method that can substantially quantify the value of a control and/or sub-metering solution, as it relates to the commercial and industrial energy management space. The system and method disclosed herein can allow for the determination and presentation of the monetization of relevant data streams in a unified fashion such that energy insights can be objectively quantified as can the costs of inaction and the benefits of action.

The present technology can allow energy users to understand the value of both control and monitoring of an industrial and/or commercial system in order to take appropriate action. With the system and method disclosed herein, developers of energy management systems (EMS) can comprehensively demonstrate return-on-investment (ROI) and substantially accurately portray the savings capacity of installing an energy management system at a location.

Savings in a commercial and industrial energy management system can be realized either through control of on-premises devices like HVACs, lighting zones, coolers/freezers, etc. or through modifications made to the state of the premises based on monitoring/measurement information derived from sensors. The unification and combination of these different methodologies and streams of data can form a comprehensive picture of system savings and value of the system.

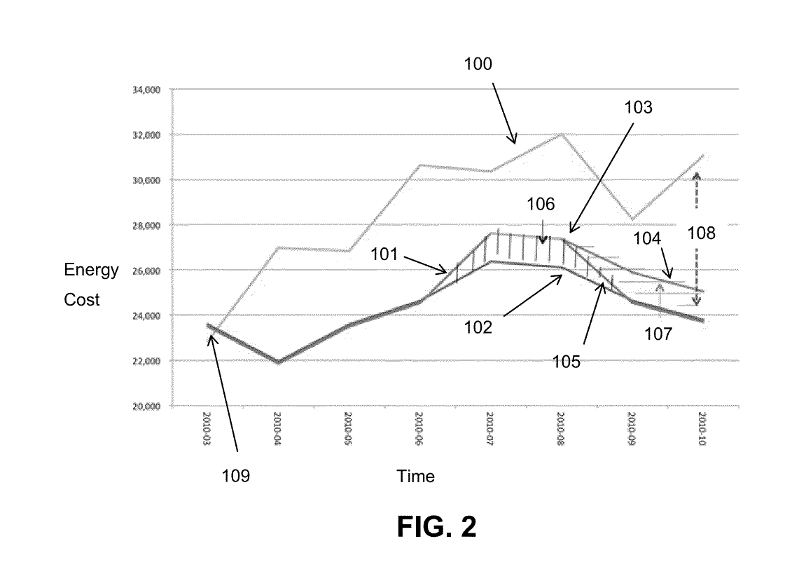

FIG. 2 is a chart of energy consumption over time, illustrating the discretized, granular valuations that can be provided for potential savings maximization, according to various embodiments of the present technology.

FIG. 2 plots a first predictive model 100, an actual energy usage 101, and a second predictive model 102.

The first predictive model 100 represents the energy cost of operating without an energy management system over time. The second predictive model 102 represents the energy cost of operating with an energy management system over time.

The actual energy usage 101 represents the actual energy cost over time. Actual cost 101 can be derived either through processing of customer electrical bills or by measuring main load via premises equipment and running the energy (kWh) outputs through a rate engine if actual billing data is unavailable (Actual Energy Use).

Even though savings can be derived from the delta between the first predictive model 100 and the actual energy usage 101, additional savings can be described through monetization of exceptional conditions (alarms). The exceptional conditions can be determined through the operation of on-premises sensors and classified by automated server algorithms. These exceptional conditions can be conceived as realized savings, if it is assumed that action was taken to correct the exceptional conditions, once an alarm is initiated. Some of these savings can be objective, tangible, and immediate such as the case where alarms expose an improperly elevated load or an improperly activated lighting override. Other savings may be objective, tangible, but not immediate such as the case where an elevated polyphase voltage imbalance over the course of a month may lead to the shortened life of an expensive Roof Top Unit (RTU). Finally, savings can be subjective and intangible such as the case where poor temperature control in a refrigeration unit of a store results in customers receiving poorly cooled beverages thereby decreasing their customer satisfaction and decreasing the likelihood of their continued patronage. Unrealized or potential savings can also be quantified. These can include the savings that could have been captured if timely and appropriate action had been taken in response to notification of exceptional conditions.

For exemplary purposes, the actual energy usage 101 branches at a branch point 103 into a continued actual usage line 105 and a predicted actual usage line 104. At the branch point 103, it is assumed that the second predictive model 102 is implemented, resulting in a decrease in energy cost over time. Therefore, the continued actual usage line eventually converges with the second predictive model 102. The predicted actual usage line 104 represents the energy cost that would have been realized if the second predictive model 102 had not been adopted at the branch point 103. The predicted actual usage line 104 can be calculated as described herein.

Potential savings area 106 is bounded on the top by actual energy usage 101 and the second predictive model 102. Therefore, potential savings area 106 represents the potential savings of implementing the features associated with the second predictive model 102, for example alarms. A first realized savings area 104 is bounded by predicted actual usage line 104 and continued actual usage line 105. Therefore, the first realized savings area 104 represents an amount of savings in energy costs over time that are realized after implementing the features associated with the second predicative model 102 at branch point 103.

Still referring to FIG. 2, the starting point 109 demarcates the point at which an energy management system can be installed at a given site. From starting point 109 on, one of several predictive models (100, 102) can be used to describe what the energy cost for the site would have been sans retrofit. A second realized savings area 108 is bounded by the first predictive model 100 and the second predictive model 102. Therefore, the second realized savings area 108 represents the total savings realizable by implementing an energy management system.

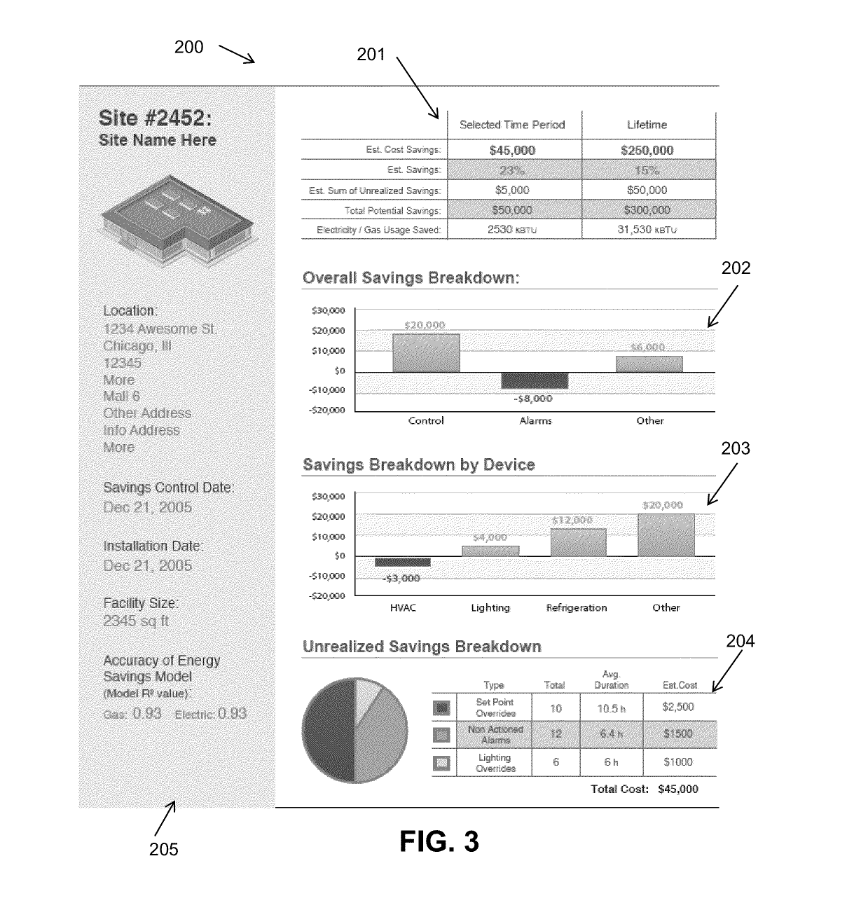

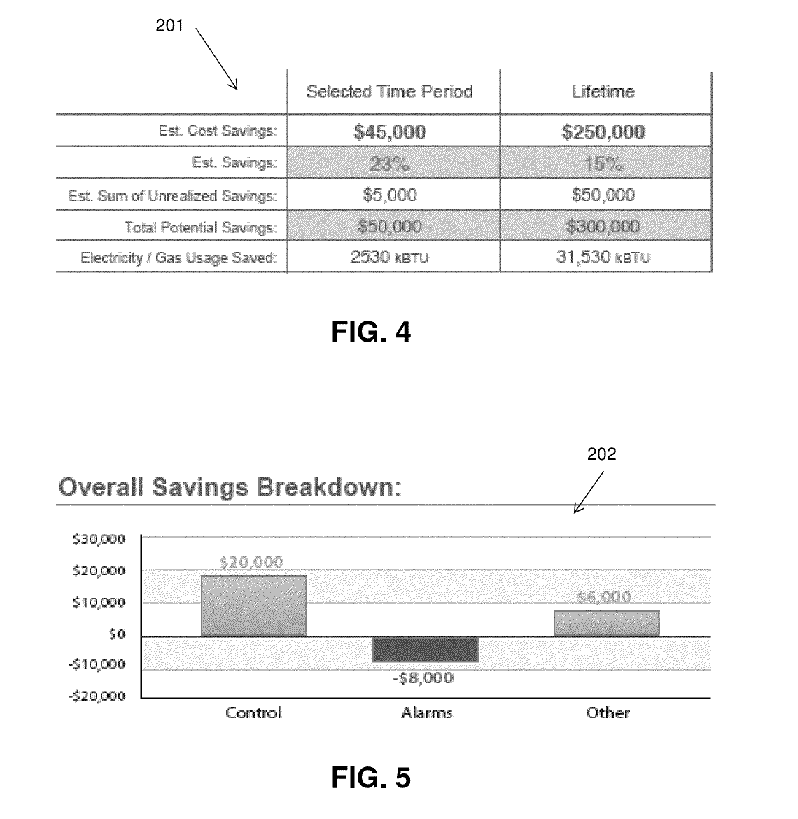

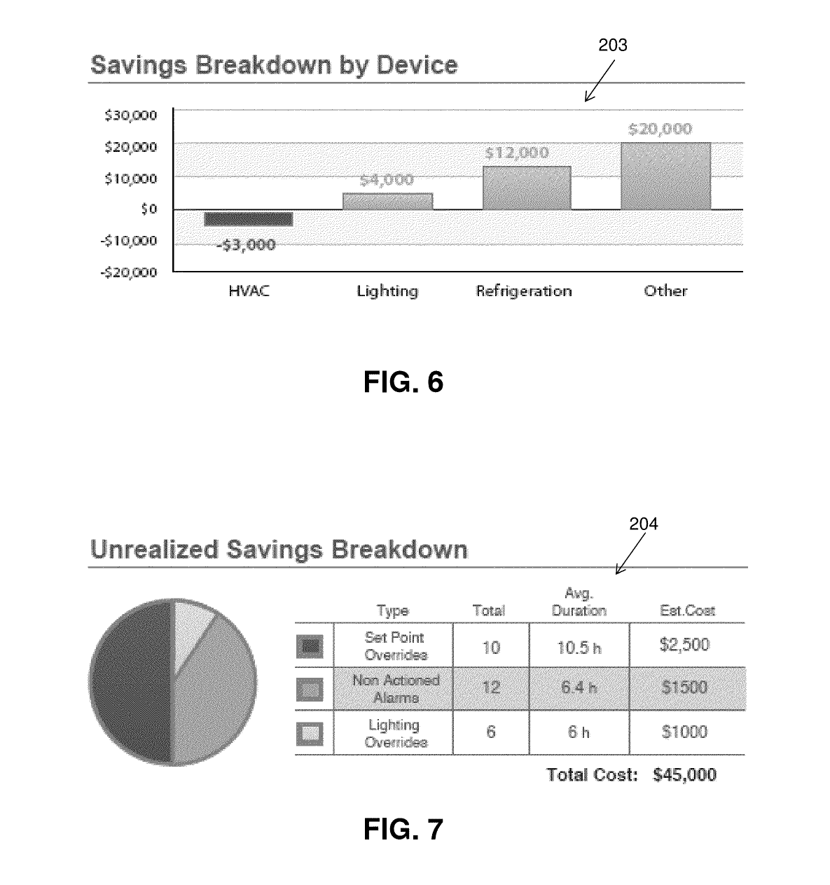

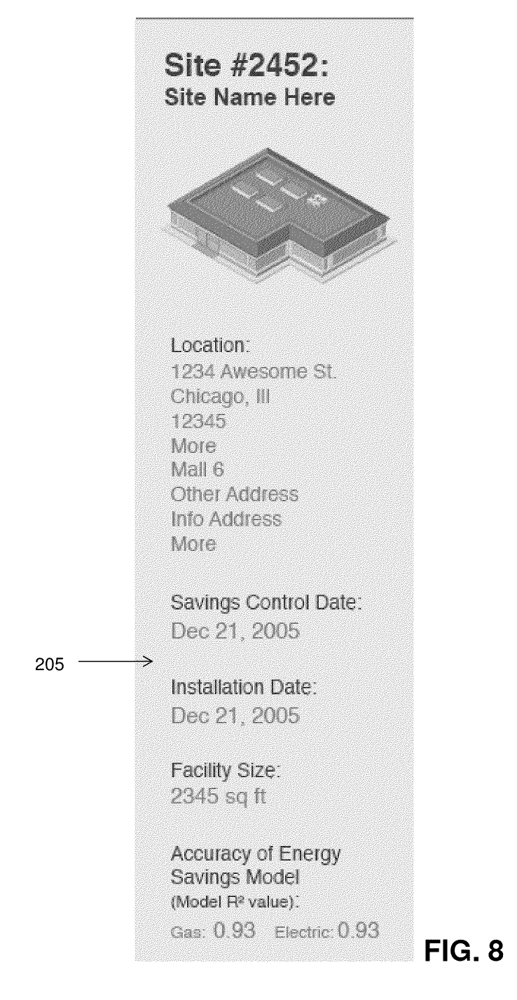

By combining some or all of the above factors into a unified and consistent savings model, an energy management equipment and software vendor can aim to provide a report or dashboard 200 as illustrated in FIG. 3. The report or dashboard 200 can include a time-based summary 201 of realized and/or estimated costs over various time periods. The report or dashboard 200 can include a control-type summary 202 of estimated costs associated with various control or monitoring schemes. The report or dashboard 200 can include a device-breakdown summary 203, showing savings or expenses realized for various devices. The report or dashboard 200 can include an unrealized savings summary 204, indicating the total unrealized savings associated with failures to adopt a recommended energy management system and/or associated with deviations or overrides of implemented energy management systems. Finally, the report or dashboard 200 can include a site summary 205, providing relevant details for the particular site being evaluated.

### Example 1

The cost of leaving a single incandescent light bulb on for 4 hours can be monetized, assuming a simple flat rate of $0.10/kWh, as shown in Equation 1.

incremental cost=(4 h*100 W*$0.00010/Wh)=$0.04 Eq. 1

### Example 2

HVAC systems represent a significant amount of the overall energy consumption at a site. For a given HVAC system, an energy profile can be established indicating the expected electrical consumption of a unit at a given setpoint and outdoor temperature. A deviance in the energy profile due to equipment issues can be identified and quantified. For example, an incremental cost can be calculated as shown in Equation 2.

Incremental cost=(actual kWh usage−expected kWh usage)*rate Eq. 2

### Example 3

Another way to monetize the alarm is to show the effect of the alarm on capital at risk. Capital monetization can be applied to the light-bulb from Example 1, as well. Assuming that a standard incandescent light bulb has a life of 900 hours, so in addition to the cost of the energy used, the light bulb will wear out sooner. The capital cost of the light bulb can be calculated as shown in Equation 3.

(4 h)(1 bulb/900 h)*($0.25/bulb)=$0.0011 Eq. 3

### Example 4

Various embodiments of the invention valuate efficiency loss. An extreme polyphase voltage imbalance (PVI) of 5% can derate a polyphase motor by a factor of 0.76 (See: http://www.engineeringtoolbox.com/electrical-motor-voltage-imbalance-d_{—}648.html). The cost of the energy loss due to the inefficiency during the voltage imbalance for a 18 kW motor, such as one used by an air-conditioning system, can be calculated according to Equation 4.

CE=(PVI duration)*(MAP)*(1−derating factor)*(billing rate) Eq. 4

where CE is the cost of the energy loss due to the inefficiency during a voltage imbalance, and MAP is the motor's average power usage during PVI).

For a short eight-hour imbalance, but most PVI conditions persist for weeks or months before correction, so costs will be much higher over the long term. Equation 5 evaluates Equation 4 based on these exemplary conditions

CE=(8 h)*(9 kW)*(1−0.76)*$0.10/kWh=$1.728 Eq. 5

Continuing this example, capital monetization can be applied in the case of a polyphase voltage imbalance. In addition to the cost of the immediate inefficiency, voltage imbalances can permanently damage polyphase motors. For example, suppose a one-month polyphase voltage imbalance takes 5 years off the life of a rooftop HVAC unit (RTU). If the typical life expectancy of an RTU is 20 years, and its cost is $10,000, then this can be calculated as shown in Equations 6-8.

normal_month_depreciation=$10,000/240 months=$41.67/month Eq. 6

this_month_depreciation=($10,000*0.25)/1 month=$2500/month Eq. 7

pvi_cost=($2500 month−$41.67/month)*1 month=$2458.33 Eq. 8

### Example 5

According to another embodiment, if a refrigeration system becomes too warm or too cold, then the items in the refrigerator are at risk. In such an example, the cost of such an alarm can be equal to the disposal and replacement value of items in the refrigeration system.

The proposed method provides a system and method of quantifying energy usage profiles for individual load classes. For example, load classes can include HVAC, refrigeration, heating, lighting, or other load classes. The system and method described herein can provide finer granularity in savings analysis and can enable the system to quantify the monetary impact of performance issues at an equipment level in real-time.

Although the present invention has been described in considerable detail with reference to certain preferred versions thereof, other versions are possible. For example, it is clearly possible to incorporate some or all of the approaches described herein or they can be implemented independently. However, in at least one embodiment, the approach derives from a cohesive implementation as stated in this disclosure. Furthermore, the system and method of valuating can be related to industrial or commercial systems having cooling equipment, temperature control equipment, lighting equipment, industrial machinery, manufacturing machinery, household appliances, or other power-consuming (fuel or electricity) devices found in commercial and industrial systems. Therefore, the spirit and scope of the appended claims should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C §112, sixth paragraph. In particular, the use of “step of” in the claims herein is not intended to invoke the provisions of 35 U.S.C §112, sixth paragraph.

What is claimed is:

1. A non-transitory computer readable medium having computer-readable code stored thereon for causing a computer to perform a method of valuating an energy management system implemented at a site, the method comprising:
receiving data from at least one energy-consuming device,
wherein the at least one energy-consuming device is associated with the energy management system
wherein the data comprises at least one operating parameter of the at least one energy-consuming device for a time interval;
determining an amount of energy consumed by the device during the time interval;
calculating an actual energy cost based on the determined amount of energy consumed by the device during the time interval;
predicting an amount of energy that would have been consumed by the at least one device during the time interval if the at least one device were not associated with the energy management system;
calculating a predicted energy cost based on the predicted amount of energy that would have been consumed by the at least one device during the time interval if the at least one device were not associated with the energy management system;
calculating a valuation of the energy management system for the at least one energy consuming device over the time interval by comparing the actual energy cost and the predicted energy cost;
sending a representation of the valuation to a notification receiving device.

2. The non-transitory computer readable medium of claim 1, wherein the at least one energy-consuming device is associated with the energy management system in that the at least one energy-consuming device is controlled by the energy management system, and
wherein the predicted amount of energy is the amount of energy that would have been consumed by the at least one device during the time interval if the at least one device were not controlled by the energy management system.

3. The non-transitory computer readable medium of claim 1, wherein the at least one energy-consuming device is associated with the energy management system in that the at least one energy-consuming device is monitored by the energy management system, and
wherein the predicted amount of energy is the amount of energy that would have been consumed by the at least one device during the time interval if the at least one device were not monitored by the energy management system.

4. The non-transitory computer readable medium of claim 1, wherein the at least one energy-consuming device is associated with the energy management system in that the at least one energy-consuming device is controlled and monitored by the energy management system,
wherein the predicted amount of energy comprises a first prediction component and a second prediction component,
wherein the first prediction component of the predicted amount of energy is the amount of energy that would have been consumed by the at least one device during the time interval if the at least one device were not controlled by the energy management system
wherein the second prediction component of the predicted amount of energy is the amount of energy that would have been consumed by the at least one device during the time interval if the at least one device were not controlled by the energy management system.

5. The non-transitory computer readable medium of claim 4, wherein the valuation of the energy management system comprises a first valuation component and a second valuation component;
wherein the first valuation component provides a valuation of controlling the at least one device with the energy management system,
wherein the first valuation component is determined by comparing the actual energy cost and the first prediction component of the predicted amount of energy;
wherein the second valuation component provides a valuation of monitoring the at least one device with the energy management system; and
wherein the second valuation component is determined by comparing the actual energy cost and the second prediction component of the predicted amount of energy.

6. The non-transitory computer readable medium of claim 1, wherein predicting the amount of energy that would have been consumed by the at least one device during the time interval if the at least one device were not associated with the energy management system comprises applying a multi-variable linear regression based on at least 12 months of billing data for the site to construct a weather normalized model for the site.

7. The non-transitory computer readable medium of claim 1, wherein predicting the amount of energy that would have been consumed by the at least one device during the time interval if the at least one device were not associated with the energy management system comprises evaluating at least one weather adjusted usage average of energy consumption at a second site.

8. The non-transitory computer readable medium of claim 1, wherein predicting the amount of energy that would have been consumed by the at least one device during the time interval if the at least one device were not associated with the energy management system comprises evaluating at least one square-footage adjusted average of energy consumption at a second site.

9. The non-transitory computer readable medium of claim 1, wherein data from a plurality of energy-consuming devices is received and valuated.

10. The non-transitory computer readable medium of claim 9, wherein the valuation comprises an individual valuation for each of the plurality of energy-consuming devices.

11. The non-transitory computer readable medium of claim 1, wherein the at least one energy-consuming device is selected from the group consisting of HVAC, lighting, refrigeration, climate control systems, manufacturing equipment systems, and combinations thereof.

12. A method of valuating an energy management system implemented at a site, the method comprising:
receiving, via a processor, data from at least one energy-consuming device,
wherein the at least one energy-consuming device is associated with the energy management system
wherein the data comprises at least one operating parameter of the at least one energy-consuming device for a time interval;
determining, via a processor, an amount of energy consumed by the device during the time interval;
calculating, via a processor, an actual energy cost based on the determined amount of energy consumed by the device during the time interval;
predicting, via a processor, an amount of energy that would have been consumed by the at least one device during the time interval if the at least one device were not associated with the energy management system;
calculating, via a processor, a predicted energy cost based on the predicted amount of energy that would have been consumed by the at least one device during the time interval if the at least one device were not associated with the energy management system;
calculating, via a processor, a valuation of the energy management system for the at least one energy consuming device over the time interval by comparing the actual energy cost and the predicted energy cost;
sending, via a processor, a representation of the valuation to a notification receiving device.

13. The method of claim 12, wherein the at least one energy-consuming device is associated with the energy management system in that the at least one energy-consuming device is controlled by the energy management system, and
wherein the predicted amount of energy is the amount of energy that would have been consumed by the at least one device during the time interval if the at least one device were not controlled by the energy management system.

14. The method of claim 12, wherein the at least one energy-consuming device is associated with the energy management system in that the at least one energy-consuming device is monitored by the energy management system, and
wherein the predicted amount of energy is the amount of energy that would have been consumed by the at least one device during the time interval if the at least one device were not monitored by the energy management system.

15. The method of claim 12, wherein the at least one energy-consuming device is associated with the energy management system in that the at least one energy-consuming device is controlled and monitored by the energy management system,
wherein the predicted amount of energy comprises a first prediction component and a second prediction component,
wherein the first prediction component of the predicted amount of energy is the amount of energy that would have been consumed by the at least one device during the time interval if the at least one device were not controlled by the energy management system
wherein the second prediction component of the predicted amount of energy is the amount of energy that would have been consumed by the at least one device during the time interval if the at least one device were not controlled by the energy management system.

16. The method of claim 15, wherein the valuation of the energy management system comprises a first valuation component and a second valuation component;
wherein the first valuation component provides a valuation of controlling the at least one device with the energy management system,
wherein the first valuation component is determined by comparing the actual energy cost and the first prediction component of the predicted amount of energy;
wherein the second valuation component provides a valuation of monitoring the at least one device with the energy management system; and
wherein the second valuation component is determined by comparing the actual energy cost and the second prediction component of the predicted amount of energy.

17. The method of claim 12, wherein predicting the amount of energy that would have been consumed by the at least one device during the time interval if the at least one device were not associated with the energy management system comprises applying a multi-variable linear regression based on at least 12 months of billing data for the site to construct a weather normalized model for the site.

18. The method of claim 12, wherein predicting the amount of energy that would have been consumed by the at least one device during the time interval if the at least one device were not associated with the energy management system comprises evaluating at least one weather adjusted usage average of energy consumption at a second site.

19. The method of claim 12, wherein predicting the amount of energy that would have been consumed by the at least one device during the time interval if the at least one device were not associated with the energy management system comprises evaluating at least one square-footage adjusted average of energy consumption at a second site.

20. The method of claim 12, wherein data from a plurality of energy-consuming devices is received and valuated.

21. The method of claim 20, wherein the valuation comprises an individual valuation for each of the plurality of energy-consuming devices.

22. The method of claim 12, wherein the at least one energy-consuming device is selected from the group consisting of HVAC, lighting, refrigeration, climate control systems, manufacturing equipment systems, and combinations thereof.
